(19) United States
(12) Patent Application Publication
(10) Pub. No.: US 2007/0070831 A1
(43) Pub. Date: Mar. 29, 2007

(54) "Electronic device and system for reproducing content"

(75) Inventors: Daniel Willem Elisabeth Schobben, EINDHOVEN (NL); Christiaan De Jager, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/539,321

(22) PCT Filed: Nov. 20, 2003
(86) PCT No.: PCT/IB03/05450

§ 371 Date: Jun. 15, 2005

(30) Foreign Application Priority Data
Dec. 19, 2002 (EP) 02080379.7

(51) Int. Cl. G11B 17/22

(52) U.S. Cl. 369/30.32

(57) ABSTRACT

The electronic device (1) of the invention contains a control unit (5) which is able to receive from a detector (9) a signal indicating insertion of an object (23) into an object holder (21) and/or removal of the object from the object holder (21). The control unit (5) is further able to use a reproduction means (7) to start reproduction of content in dependency on the signal from the detector (9). The object holder (21) of the invention contains a detector which is able to detect an insertion of an object into the object holder (21) and/or a removal of the object (23) from the object holder (21). The detector (9) is further able to generate a signal indicating the insertion and/or the removal and containing an identifier identifying the object and/or a further identifier identifying the object holder (21) and/or a position in the object holder (21). The system of the invention comprises the electronic device (1) and the object holder (21).

The invention relates to an electronic device for reproducing content, comprising a control unit which is able to use a reproduction means to reproduce content.

The invention further relates to an object holder.

The invention also relates to a system for reproducing content.

An embodiment of this electronic device is known in the field of consumer electronics. Traditional consumer devices for reproducing content are cassette players and CD players. Inserting a removable medium into such a device and pressing a play button results in reproduction of content of the removable medium. A new generation of consumer devices comprises a CD-reader and a hard disk caching facility. Music can be read from a CD and stored on a hard disk, possibly in compressed format. A user of the consumer device is able to select a cached CD and/or a track from the cached CD to be played using, for example, controls and a display of the consumer device. The user is no longer required to insert the CD before its content can be reproduced, thereby preventing damage to the CD and thus preventing errors in playback.

A drawback of the known electronic device is its inability to allow a user to start reproduction of a cached CD quickly. A user has to navigate through multiple menus to find the cached CD he or she is looking for. In addition, the menu structure may not always be clear to the user, e.g. if cached CDs have been ordered by category.

It is a first object of the invention to provide an electronic device of the kind described in the opening paragraph, which allows a user to start reproduction of content more quickly.

It is a second object of the invention to provide an object holder of the kind described in the opening paragraph, which allows a user to start reproduction of content more quickly.

According to the invention, the first object is realized in that the control unit is able to receive from a detector a signal indicating an occurrence of one of: a first event comprising insertion of an object into an object holder and a second event comprising removal of the object from the object holder; and the control unit is able to use the reproduction means to start reproduction of content from a storage means in dependency on the signal from the detector.

Browsing through a collection of objects is much easier than browsing through a long list of titles on a screen. An object holder can be used to store an object permanently, i.e. most of the time, or temporarily. By enabling the electronic device to start reproduction when an object is inserted into or removed from the object holder, a user of the electronic device is able to start reproduction of content of the removable medium quickly. As an additional advantage, the user can easily identify from the object holder what content is being reproduced. The object may be, for example, a case of a CD or DVD. Alternatively, if consumers were to download content, they would probably still desire a physical memento. The physical memento may comprise a digital right, e.g. a code or a chip-card, allowing reproduction of the content. The electronic device may be able to download content when a physical memento is inserted into the object holder for the first time. Furthermore, the electronic device or a system on a network, e.g. on the Internet, may comprise, for example, the storage means and the object may represent a category of content, e.g. classical music.

In an embodiment of the electronic device of the invention, the electronic device further comprises the storage means and the control unit is further able to store on the storage means content from a removable medium, an identifier of a case of the removable medium, and an association between the content and the identifier. In this embodiment, the control unit is able to receive from the detector a signal indicating an occurrence of one of: a first event comprising insertion of the case into a case holder and a second event comprising removal of the case from the case holder. Many consumers own a collection of removable media packaged in cases, e.g. CDs and/or DVDs. These cases can advantageously be reused to select content to be reproduced. The control unit may also be able to store on the storage means extra information retrieved from a system on a network, e.g. from a system on the Internet offering a CDDB service. The extra information may comprise, for example, a title and/or a name of an artist. The control unit may be able to use an output means, e.g. a display of the electronic device, to display the extra information.

The electronic device may further comprise a reader which is able to read the removable medium and the control unit may be able to instruct the reader to read the content from the removable medium. Alternatively, the electronic device may be connected to a further electronic device comprising the reader and the electronic device may be able to receive the content from the further electronic device. The further electronic device may be, for example, a CD player, a DVD player, or a PC. The electronic device may also be able to use an output means, e.g. a TV or a display of the electronic device, to instruct a user of the electronic device to insert the removable medium into the reader if no association between the identifier and the content is stored on the storage means.

The control unit may be able to receive a signal indicating a way of inserting the object into the object holder and the control unit may be able to use the reproduction means to start reproduction of a part of the content, the part of the content being dependent on the way of inserting the object into the object holder. A case of a CD may be, for example, be completely or partly inserted into a case holder. Inserting the case with its rearside up or it its rearside down is another example of a way of inserting a case into a case holder. This feature may, for example, allow selecting a track of a cached CD or DVD and/or selecting a sequential or random reproduction of all tracks on a cached CD or DVD.

The control unit may be able to use the reproduction means to start reproduction of the content if an occurrence of the second event is indicated in the signal. This feature is favorable in an embodiment in which an object holder is used to hold an object permanently, e.g. most of the time but not during reproduction of the content. Each object may be assigned to an object holder and removing an object from its object holder may trigger the electronic device to start reproduction. If a further object is removed from the object holder while the electronic device is already reproducing content, the electronic device may be able to delay reproduction of the further content identified by the further object. If the content comprises multiple parts, the further content or a part of the further content may be reproduced in between the reproduction of the multiple parts.

The control unit may be able to use the reproduction means to stop reproduction of the content if an occurrence of the first event is indicated in the signal. Putting the object back into the object holder may trigger the electronic device to stop reproduction. Alternatively, a stop button may be integrated into the object holder.

The control unit may be able to receive a further identifier identifying at least one of: the object holder and a position in the object holder and to retrieve the identifier from a further storage means using the further identifier. If an external object holder does not contain memory in which the identifier of the removable medium can be written, it may contain a fixed object holder identifier in read-only memory. The further storage means may be comprised in the electronic device or in another electronic device.

The control unit may be able to use the reproduction means to start reproduction of the content if an occurrence of the first event is indicated in the signal and to stop reproduction of the content if an occurrence of the second event is indicated in the signal. This feature is favorable in an embodiment in which an object holder is used to hold an object temporarily, e.g. only during reproduction of the content. In this embodiment, the object holder may be able to hold one of many objects. Inserting an object into the object holder may trigger the electronic device to start reproduction and removing the object from the object holder may trigger the electronic device to stop reproduction. If a further object is inserted into the object holder while the electronic device is already reproducing content, the electronic device may be able to delay reproduction of the further content identified by the further object. If the content comprises multiple parts, the further content or a part of the further content may be reproduced in between the reproduction of the multiple parts.

The control unit may be able to instruct a sensing means to obtain the identifier by sensing the object, e.g. a case of a removable medium. Alternatively, the identifier, e.g. a bar code, could be provided manually, e.g. by using a remote control. The control unit may also be able to instruct the sensing means to sense the way of inserting the object into the object holder, e.g. an orientation of the object.

According to the invention, the second object is realized in that the object holder comprises a detector which is able to detect an occurrence of at least one of: a first event comprising insertion of the object into the object holder and a second event comprising removal of the object from the object holder, and able to generate a signal indicating the occurrence and comprising at least one of: an identifier identifying the object and a further identifier identifying at least one of: the object holder and a position in the object holder.

The object holder may be able to allow a way of inserting an object. The detector may further be able to detect the way of inserting the object into the object holder and to incorporate an identification of the way of inserting the object into the object holder in the signal.

The object holder may further comprise a sensing means, and the detector may be able to instruct the sensing means to obtain the identifier by sensing the object, e.g. a case of a removable medium. This may enable the detector to generate a signal comprising the identifier. Alternatively, the electronic device may be able to instruct a sensing means to obtain the identifier and the detector may be able to generate a signal comprising the further identifier. If one object is assigned to one object holder or to one position in the object holder, a sensing means may be instructed to obtain the identifier before the one object is inserted into the one object holder or the one position for the first time. A relation between the identifier and the further identifier may be stored in a memory comprised in the object holder. The detector may then also be able to generate the signal comprising the identifier.

These and other aspects of the electronic device, the object holder, and the system of the invention will be further elucidated and described with reference to the drawings, in which:

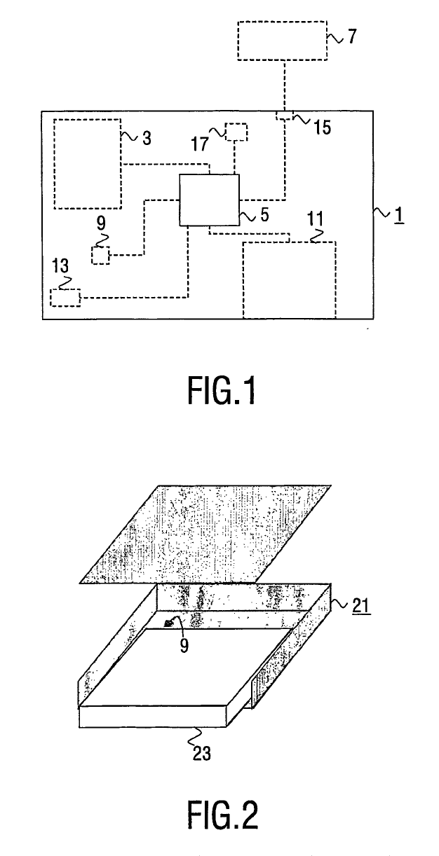

FIG. 1 is a block diagram of the electronic device;

FIG. 2 is a perspective view of a first embodiment of the object holder;

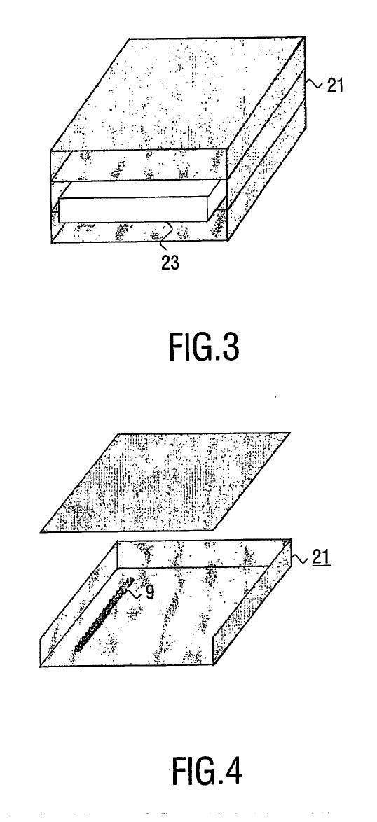

FIG. 3 is a perspective view of a second embodiment of the object holder;

FIG. 4 is a perspective view of a third embodiment of the object holder;

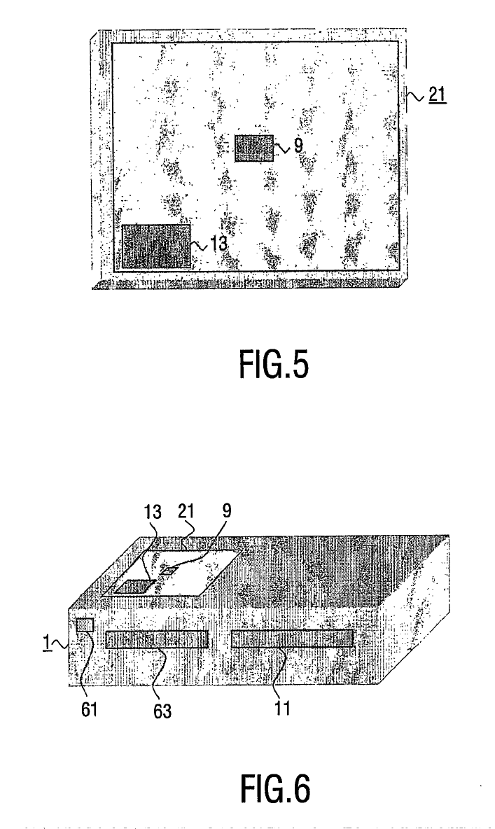

FIG. 5 is a perspective view of a fourth embodiment of the object holder;

FIG. 6 is a perspective view of an embodiment of the electronic device;

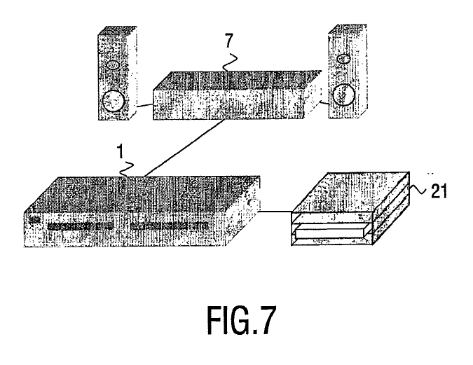

FIG. 7 is a block diagram of the system;

Corresponding elements in the drawings are identified by the same reference numerals.

Electronic device 1, see FIG. 1, is an electronic device for reproducing content, comprising a control unit 5 which is able to use a reproduction means 7 to reproduce content. The control unit 5 is able to receive from a detector 9 a signal indicating an occurrence of one of: a first event comprising insertion of an object 23, shown in FIG. 2 and FIG. 3, into an object holder 21, shown in FIG. 2-FIG. 6, and a second event comprising removal of the object 23 from the object holder 21. The control unit 5 is furthermore able to use the reproduction means 7 to start reproduction of content from a storage means 3 in dependency on the signal from the detector 9. The reproduction means 7 may be, for example, an internal speaker comprised in the electronic device, an external speaker, a headphone, or an amplifier coupled to a speaker or a headphone. If the reproduction means 7 is not comprised in the electronic device 1, it may be coupled to the electronic device 1 through a connector 15. The control unit 5 may be, for example, a microprocessor. The detector 9 may comprise, for example, a mechanical switch or a light-sensitive sensor. The storage means 3 may be a hard disk.

The electronic device 1 may further comprise the storage means 3. The control unit 5 may further be able to store on the storage means 3 content from a removable medium, an identifier of a case, shown as an embodiment of the object 23 in FIG. 2 and FIG. 3, of the removable medium, and an association between the content and the identifier. The control unit 5 may be able to receive from the detector 9 a signal indicating an occurrence of one of: a first event comprising insertion of the case into a case holder and a second event comprising removal of the case from the case holder. The removable medium may be, for example, a CD, DVD, Blu-Ray, or other optical disc The case may be, for example, a jewel case or a DVD case.

The electronic device 1 may further comprise a reader 11 which is able to read the removable medium and the control unit 5 may be able to instruct the reader 11 to read the content from the removable medium.

The control unit 5 may be able to receive a signal indicating a way of inserting the object into the object holder and the control unit 5 may be able to use the reproduction means 7 to start reproduction of a part of the content, the part of the content being dependent on the way of inserting the object into the object holder. An embodiment of an electronic device 1 having this feature may be favorably used with the embodiment of the object holder shown in FIG. 4.

The control unit 5 may be able to use the reproduction means 7 to start reproduction of the content if an occurrence of the second event is indicated in the signal. The control unit 5 may be able to use the reproduction means 7 to stop reproduction of the content if an occurrence of the first event is indicated in the signal. The control unit 5 may be able to receive a further identifier identifying at least one of: the object holder 21 and a position in the object holder 21 and to retrieve the identifier from a further storage means 17 using the further identifier. The further storage means 17 may be, for example, a hard disk or solid state memory. The storage means 3 and the further storage means 17 may be logically or physically different parts of the same hardware. An embodiment of an electronic device 1 having at least one of these features may be favorably used with the embodiments of the object holder shown in FIG. 2 and FIG. 3.

The control unit 5 may be able to use the reproduction means 7 to start reproduction of the content if an occurrence of the first event is indicated in the signal and to stop reproduction of the content if an occurrence of the second event is indicated in the signal. The control unit 5 may be able to instruct a sensing means 13 to obtain the identifier by sensing the object 23. An embodiment of an electronic device 1 having at least one of these features may be favorably used with the embodiment of the object holder shown in FIG. 5. The sensing means 13 may be, for example, a bar-code scanner, a radio frequency receiver, or an image scanner. If the sensing means 13 is an image scanner, the identifier may comprise, for example, an image or characteristics of an image and the control unit 5 may be able to show the image on a TV while reproducing the content. The object 23 may comprise, for example, a bar code or transmit an RFID.

In FIG. 2, a case holder is an embodiment of the object holder 21. The object holder 21 comprises a detector 9 which is able to detect an occurrence of at least one of: a first event comprising insertion of the object 23 into the object holder 21 and a second event comprising removal of the object 23 from the object holder 21. The detector 9 is further able to generate a signal indicating the occurrence, and comprising at least one of: an identifier identifying the object and a further identifier identifying at least one of: the object holder 21 and a position in the object holder 21. In FIG. 2, the detector 9 comprises a mechanical switch. The detector 9 may be able to transmit to the electronic device 1 using a wire or using a wireless transmitter.

In FIG. 3, another embodiment of the object holder 21 is a case holder which is able to hold multiple cases. In this embodiment, the detector 9 of the object holder 21 may be able to detect a second event comprising removal of a first object 23 from a first position in the object holder 21 and a fourth event comprising removal of a second object 23 from a second position in the object holder 21. Alternatively, multiple embodiments as shown in FIG. 2 may be placed on top of one another.

In FIG. 4, another embodiment of the object holder 21 is a case holder which is able to allow a way of inserting a case. The case is an embodiment of the object 23. The detector 9 is further able to detect the way of inserting the object 23 into the object holder 21 and to incorporate an identification of the way of inserting the object 23 into the object holder 21 in the signal. In FIG. 4, the detector 9 comprises multiple mechanical switches. The state of the switches may be translated, for example, into a track number of a CD. Alternatively, the detector 9 may comprise one or more optical sensors.

In FIG. 5, another case holder is another embodiment of the object holder 21. In this embodiment, the object holder 21 further comprises a sensing means 13 and the detector 9 is able to instruct the sensing means 13 to obtain the identifier by sensing the object 23. In FIG. 5, the object 23 may be laid on top of the object holder 21.

In FIG. 6, an embodiment of the electronic device 1 is shown. This embodiment further comprises the storage means 3, shown in FIG. 1. The control unit 5, shown in FIG. 1, is further able to store on the storage means 3 content from a removable medium, an identifier of a case of the removable medium, and an association between the content and the identifier. The control unit 5 is able to receive from the detector 9, shown in FIG. 1, a signal indicating an occurrence of one of: a first event comprising insertion of the case into a case holder and a second event comprising removal of the case from the case holder. This embodiment also comprises a reader 11 which is able to read the removable medium and the control unit 5 which is able to instruct the reader 11 to read the content from the removable medium. The reader 11 may be able, for example, to read CDs and/or DVDs. The control unit 5 is able to use the reproduction means 7, shown in FIG. 1, to start reproduction of the content if an occurrence of the first event is indicated in the signal and to stop reproduction of the content if an occurrence of the second event is indicated in the signal. The control unit 5 is able to instruct a sensing means 13 to obtain the identifier by sensing an object 23.

The embodiment of FIG. 6 comprises the sensing means 13 and the detector 9. In this embodiment, one case of a removable medium may be laid on top of the electronic device 1. In another embodiment, the electronic device 1 may comprise multiple case holders. An object holder 21 holding an object 23 whose content is being reproduced or has been reproduced may be illuminated. An object holder 21 holding an object 23 whose content is being reproduced may be illuminated, for example, with a green light and an object holder 21 holding an object 23 whose content has been reproduced may be illuminated, for example, with a red light. In addition to or instead of being able to lay an object 23 on top of the electronic device 1, a user may be able to insert the object 23 into a slot comprised in the electronic device 1. The electronic device 1 may also comprise an object holder 21 in which multiple objects 23, e.g. cases, can be stacked vertically. The object 23 identifying the content being reproduced may be pushed out gradually and the user may be able to push the object 23 back in or pull the object 23 further out to select a certain part of the content for reproduction. A component in the electronic device 1, for example the object holder 21 or the detector 9, may be able to provide tactile feedback and/or force feedback in order to allow the user to select the certain part in discrete steps. The electronic device 1 may be able to use one sensing means 13 to sense multiple objects 23, e.g. by physically moving the sensing means 13 or by physically moving the objects 23. Alternatively, each object holder 21 may have one sensing means 13.

FIG. 7 shows the system for reproducing content. The system comprises an object holder 21 and an electronic device 1. The object holder 21 is able to detect an occurrence of at least one of: a first event comprising insertion of an object into the object holder 21 and a second event comprising removal of the object from the object holder 21. The object holder 21 is further able to generate a signal indicating the occurrence and comprising at least one of: an identifier identifying the object and a further identifier identifying at least one of: the object holder 21 and a position in the object holder 21. The electronic device 1 is able to receive the signal from the object holder 21 and to use the reproduction means 7 to start reproduction of content in dependency on the signal.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements.

1. An electronic device (1) for reproducing content, comprising:
a control unit which is (5) able to use a reproduction means (7) to reproduce content, characterized in that:
the control unit (5) is able to receive from a detector (9) a signal indicating an occurrence of one of: a first event comprising insertion of an object into an object holder (21) and a second event comprising removal of the object (23) from the object holder (21); and
the control unit (5) is able to use the reproduction means (7) to start reproduction of content from a storage means (3) in dependency on the signal from the detector (9).

2. An electronic device as claimed in claim 1, characterized in that:
said electronic device further comprise the storage means (3);
the control unit (5) is further able to store on the storage means (3) content from a removable medium, an identifier of a case of the removable medium, and an association between the content and the identifier; and
the control unit (5) is able to receive from the detector (9) a signal indicating an occurrence of one of: a first event comprising insertion of the case into a case holder and a second event comprising removal of the case from the case holder.

3. An electronic device as claimed in claim 2, characterized in that it further comprises a reader (11) which is able to read the removable medium, and the control unit (5) is able to instruct the reader (11) to read the content from the removable medium.

4. An electronic device as claimed in claim 1, characterized in that the control unit (5) is able to receive a signal indicating a way of inserting the object (23) into the object holder (21) and the control unit (5) is able to use the reproduction means (7) to start reproduction of a part of the content, the part of the content being dependent on the way of inserting the object (23) into the object holder (21).

5. An electronic device as claimed in claim 1, characterized in that the control unit (5) is able to use the reproduction means (7) to start reproduction of the content if an occurrence of the second event is indicated in the signal.

6. An electronic device as claimed in claim 5, characterized in that the control unit (5) is able to use the reproduction means (7) to stop reproduction of the content if an occurrence of the first event is indicated in the signal.

7. An electronic device as claimed in claim 5, characterized in that the control unit (5) is able to receive a signal comprising a further identifier identifying at least one of: the object holder (21) and a position in the object holder (21) and to retrieve the identifier from a further storage means (17) using the further identifier.

8. An electronic device as claimed in claim 1, characterized in that the control unit (5) is able to use the reproduction means (7) to start reproduction of the content if an occurrence of the first event is indicated in the signal and to stop reproduction of the content if an occurrence of the second event is indicated in the signal.

9. An electronic device as claimed in claim 1, characterized in that the control unit (5) is able to instruct a sensing means (13) to obtain the identifier by sensing the object (23).

10. An object holder (21), comprising:
a detector (9) which is able to detect an occurrence of at least one of: a first event comprising insertion of the object (23) into the object holder (21) and a second event comprising removal of the object (23) from the object holder (21), and able to generate a signal indicating the occurrence and comprising at least one of: an identifier identifying the object and a further identifier identifying at least one of: the object holder (21) and a position in the object holder (21).

11. An object holder as claimed in claim 10, characterized in that the object holder (21) is able to allow a way of inserting an object (23); and the detector (9) is further able to detect the way of inserting the object (23) into the object holder (21) and to incorporate an identification of the way of inserting the object (23) into the object holder (21) in the signal.

12. A system for reproducing content, comprising:
an object holder (23) which is able to detect an occurrence of at least one of: a first event comprising insertion of an object (23) into the object holder (21) and a second event comprising removal of the object (23) from the object holder (21), and able to generate a signal indicating the occurrence and comprising at least one of: an identifier identifying the object and a further identifier identifying at least one of: the object holder (21) and a position in the object holder (21),
an electronic device (1) which is able to receive the signal from the object holder (23) and to use the reproduction means (7) to start reproduction on content in dependency on the signal.
